(19) United States
(12) Patent Application Publication
(10) Pub. No.: US 2008/0077451 A1
(43) Pub. Date: Mar. 27, 2008

(54) System for synergistic data processing

(75) Inventors: John J. Anthony, Norwich, CT (US); Richard M. Borden, West Hartford, CT (US)

Correspondence Address: ROPES & GRAY LLP;PATENT DOCKETING 39/41, ONE INTERNATIONAL PLACE, BOSTON, MA, 02110-2624, US

(73) Assignee: Hartford Fire Insurance Company, Hartford, CT (US)

(21) Appl. No.: 11/903,927

(22) Filed: Sep. 24, 2007

Related U.S. Application Data
(60) Provisional application No. 60/847,127, filed on Sep. 22, 2006.

(51) Int. Cl. G06Q 40/00; G06F 17/30; G06F 17/40

(52) U.S. Cl. 705/4

(57) ABSTRACT

A data analysis system that includes an information mining engine for extracting structured data from unstructured data, a data store for storing the extracted structured data, data received from third party data sources, and data received from sensors monitoring insured property is described. The system also includes a business logic processor that synergistically analyzes the structured data extracted by the text mining engine, the data received from the sensor, and the data received from the third party data source to make an insurance evaluation.

### RELATED APPLICATION

This application claims the benefit of U.S. Provisional Application Ser. No. 60/847,127, filed Sep. 22, 2006, the entire contents of which are incorporated herein by reference.

### BACKGROUND OF THE INVENTION

Traditionally, to make insurance evaluations and analyses, insurance companies have relied upon form documents in which customers, adjusters, agents, etc. enter data. Data typically is entered by selecting from predetermined options, for example, by checking a box, and by entering free form text into appropriate portions of the form. Frequently, much of the free form text is ignored due to limitations in insurers' ability to automatically code information in the text. More recently, similar information is obtained from computerized forms. Insurers have also begun exploring other means of obtaining data.

### SUMMARY OF THE INVENTION

A number of insurance companies have begun exploring new ways of gathering data to improve the various analyses they make on a daily basis in conducting their business. For example, some automobile insurers have experimented in collecting from insured vehicles sensor data they believe to be indicative of the risk insuring the vehicle poses to the insurer. Other insurance companies have considered using various data mining techniques, including text mining to extract additional information from collected data which previously had been unsuited for incorporation into business analyses and decisions. Still other insurance companies have looked to third party data sources, for example, credit rating agencies or motor vehicle bureaus, for information to incorporate into their decision making process.

None of the insurance companies, however, have recognized the synergies that result from basing insurance evaluations on combinations of these non-traditional data sources. For example, information derived from mining text can be verified against sensor and/or third party-provided data. Third party data can provide context to information received from sensors. For example, sensor data can inform a insurer of the location of an insured property, but the relevance of that location can be informed by obtaining crime rate data for the location from government or private data sources.

In addition, the value of the information collected from one or more of these sources can be augmented by feeding the data into various predictive models. Neural networks, Hidden Markov Models, genetic algorithms, and other algorithms and systems known in the art for high-dimensional computation can be employed to analyze the large number of parameters that can be extracted from non-traditional sources of data. Neural networks and Hidden Markov Models, in addition, can be trained automatically on historical data to obtain more accurate results than could be derived from expert systems or systems with user-defined rules.

According to one aspect the invention relates to a data analysis system that includes a text mining engine for extracting structured data from unstructured text, a data store for storing the extracted structured data, data received from third party data sources, and data received from sensors monitoring insured property. The system also includes a business logic processor that synergistically analyzes the structured data extracted by the text mining engine, the data received from the sensor, and the data received from the third party data source to make an insurance evaluation.

In various embodiments, the system also includes a relationship engine. The relationship engine, in one embodiment identifies linkages between data fields stored in the data store. For example, the relationship engine identifies linkages between data fields and third party data sources from which data is available to populate the respective data fields. In another embodiment, the relationship engine is configured to identify a linkage between a data field stored in the data store and the sensor monitoring the insured property in order to obtain data to populate the data field.

In one embodiment, the business logic processor includes a predictive model for detecting fraud in an insurance claim based on a combination of the structured data extracted by the text mining engine, the data obtained from the sensor, and the data collected from the third party data source. In another embodiment, the business logic processor comprises a predictive model for detecting fraud in an application for insurance based on a combination of the structured data extracted by the text mining engine, the data obtained from the sensor, and the data collected from the third party data source. In still another embodiment, the business logic processor includes a predictive model for evaluating a loss associated with an insurance claim based on a combination of the structured data extracted by the text mining engine, the data obtained from the sensor, and the data collected from the third party data source. In yet another embodiment, the business logic processor includes a predictive model for underwriting an application for insurance based on a combination of the structured data extracted by the text mining engine, the data obtained from the sensor, and the data collected from the third party data source.

According to another aspect, the invention relates to a method of making an insurance evaluation. The method includes receiving data from a text mining engine, a third party data source, and a telematics sensor. The received data is then processed by a business logic processor including a predictive model to determining a likelihood of insurance fraud, a premium price, an underwriting rating, an estimated ultimate severity, or a likelihood of subrogation. In one embodiment, the output of the predictive model is used to alter a step in an insurance work flow based on the determination. For example, medical treatment recommendations may be varied, factual investigations may be initiated, or personnel responsible for an insurance application or claim may be reallocated to more effectively process the application or claim.

In one embodiment, the method includes a data verification process. The verification process may detect a falsehood, error, omission, or it may adjust a confidence level in a datum. For example, data received from the telematics sensor may be analyzed to verify data received from the text mining engine or the third party data source. Similarly, data received from the third party data source may be analyzed to verify data received from the text mining engine or the telematics sensor. In another embodiment, receiving the data from the third party data source based on the data received from the telematics sensor substantially increases the reliability of the data received from the third party data source. In still another embodiment, the data received from the third party data source is used to interpret the implications of the data received from the telematics sensor.

In one embodiment, the process of obtaining data from the third party data source includes several steps. At least one data field utilized by the predictive model for which data is not currently stored in a data store is identified. A third party data source from which data is available to populate the data field is then identified. Then, in one embodiment, the identified third party data source is queried using the data received from the telematics sensor to obtain the data from the third party data source. In another embodiment, the third party data source is queried using the data received from the telematics sensor and the data received from the text mining engine to obtain the data from the third party data source.

### BRIEF DESCRIPTION OF THE DRAWINGS

The foregoing discussion will be understood more readily from the following detailed description of the invention with reference to the following drawings:

FIG. 1 is a block diagram of a system for insurance evaluation making according to an illustrative embodiment of the invention.

FIG. 2 is a flow chart illustrating a method for detecting fraud using the system of FIG. 1, according to an illustrative embodiment of the invention.

FIG. 3 is a flow chart of a method for claim analysis associated with a claim using the system of FIG. 1, according to an illustrative embodiment of the invention.

FIG. 4 is a flow chart of a method for underwriting a request for insurance using the system of FIG. 1, according to an illustrative embodiment of the invention.

### DETAILED DESCRIPTION OF AN ILLUSTRATIVE EMBODIMENT

To provide an overall understanding of the invention, certain illustrative embodiments will now be described. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

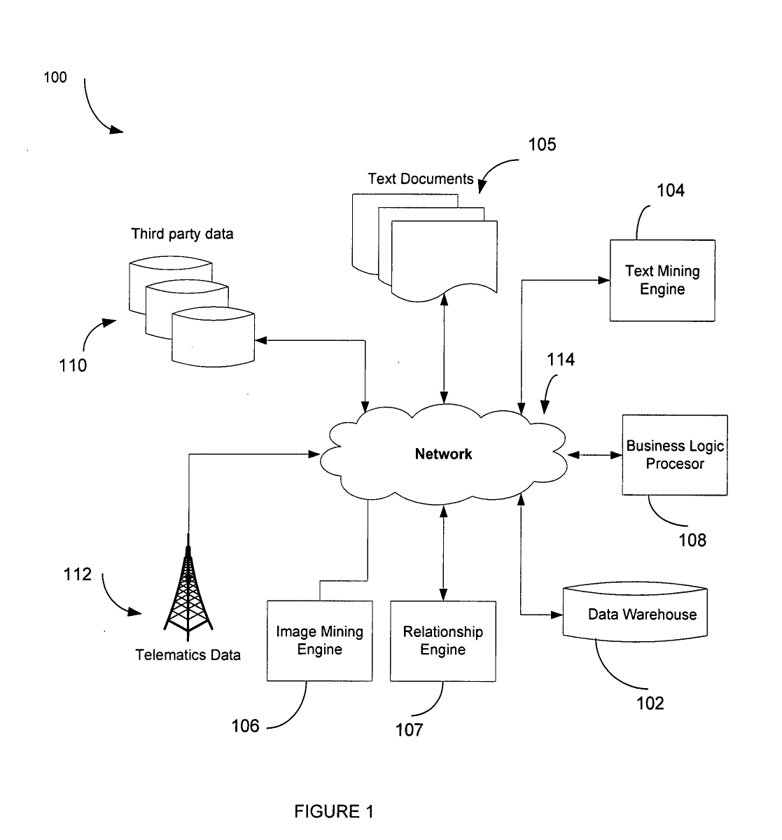

FIG. 1 is a block diagram of a system 100 for insurance evaluation making according to an illustrative embodiment of the invention. The system 100 can be used for making decisions in relation to, without limitation, personal lines insurance and commercial lines insurance, including for example, property and casualty insurance, liability insurance, medical insurance, workers compensation insurance, and life insurance. Suitable insurance evaluations include without limitation, underwriting decisions, fraud detection evaluations, subrogation likelihood analyses, claim analyses, and ultimate severity estimations. Insurance evaluations may also provide data for consideration by other human or computer decision making processes or systems.

The data processing system includes a data warehouse 102, a text mining engine 104, an image mining engine 106, a relationship engine 107, and a business logic processor 108. The data warehouse 102 includes one or more databases which may or may not be interrelated. The text mining engine 104 and the image mining engine 106 are both examples of information mining engine. An information mining engine is computerized process for extracting structured data from unstructured data, such as text, still images, video, or audio. The databases include data tables storing data in a structured format. The data tables in the databases are populated using data obtaining using traditional data acquisition techniques as well as by using non-traditional data sources. For example, the data tables are populated in part using structured data mined from unstructured text using the text mining engine 104, linkages identified by the relationship engine 107, data output by the business logic processor 108, and data obtained from third party data sources 110. The data warehouse 102 may also store original documents 105 processed by the text mining engine 104 for later reference, if needed.

The text mining engine 104 includes software and associated computer hardware, such as a general purpose processor, for extracting structured data from text documents. The software includes computer executable instructions encoded on a computer readable medium, such as, without limitation, a magnetic disk, optical disk, or integrated circuit memory, which when executed by the associated hardware, causes the hardware to carry out a text mining process. The text mining engine 104 optionally includes optional optical character recognition software to detect text in documents stored in an image format. In one embodiment, the text mining engine 104 includes a non-natural language parser for identifying key words in documents. The key words identified may be based on a predetermined list of words, or they may be identified by analyzing the frequency of the word in the document or a corpus of documents being analyzed. In another implementation, the text mining engine 104 includes a natural language parser for extracting semantic meaning from text in addition to detecting the presence and/or frequency of particular key words. The text-mining engine 104 may take on a number of other forms without departing from the scope of the invention. The text mining engine 104 may also include an information extraction process. The information extraction process identifies names of people, places, things, and events in documents and can also identify semantic relationships between people and objects.

Examples of text documents 105 that may be processed by the text mining engine 104 include free-form notes sections of insurance forms, transcripts of telephone calls or other oral communications related to insurance applications and insurance claims, notes from claims adjusters, and archival text documents stored in the insurance company's data warehouse in relation to previous customers, policies, and claims. All of these documents include text in an unstructured format. The text may be in a computer readable format, such as a rich text format, ASCII, word-searchable PDF, or HTML, or it may be part of an image file, for example a scan of a paper document, or a graphics file such as a JPG, non-text-searchable PDF, or TIFF file.

The text processing engine 104 may also process documents provided by third party data sources 110, including commercial and government entities. Illustrative third party text documents include news stories, product information, material safety data sheets, and documents related to medical treatments, including devices, procedures, and agents.

The image mining engine 106 extracts structured data from images. The image mining engine 106 may operate independent of, or in conjunction with the text mining engine 104, for example, to extract structured data from text in images or video. For example, the image mining engine 106 processes digital images and/or video taken by satellites, dashboard cameras, rear-view, front-view, and/or side-view automobile cameras, security cameras, or other image or video sources made available to the insurance company. For example, in the context of automobile insurance, the data extracted from dashboard images or video can identify the speed of a vehicle about the time of an accident. Video and/or images taken by exterior view cameras (front, rear, or side) can identify actions of other vehicles at or about the time of an incident. Satellite image can confirm the location of a vehicle or identify metrological or environment information related to a property.

In addition, the data tables can be populated with structured data obtained directly from third party data sources 110, without the need to resort to text, image, or video mining. Useful third party databases include, without limitation, databases of census information, motor vehicle registration and driver information, crime rates, credit histories, financial information, structural engineering data, material stress tests, etc.

The data tables in the data warehouse 102 may also be populated with telematics data 112. Telematics data 112 includes data derived from sensors monitoring the use and/or condition of an insured property, insured goods, an insured person, or structure in which the insured property, good, or person is located. For example, with respect to automobile insurance, telematics data 112 may include, without limitation, speed, location, acceleration, deceleration, environmental conditions (e.g., presence of icy roads or precipitation), tire pressure, engine use time, and vehicle diagnostic information. For insured structures, the data 112 may include, without limitation, temperature, humidity, alarm system status, smoke alarm status, and air quality. For individuals, telematics data 112 might include, without limitation, location, blood pressure, blood sugar, body temperature, and pulse. For insured goods, the data 112 may include, without limitation, the location and acceleration (e.g., to detect impacts) of the goods and data related to their surrounding environment, including, for example, temperature, humidity, and air quality. Telematics data 112 may be received wirelessly or over a wired network connection and may be encrypted.

The structured data output from the text mining engine 104, the structured data output by the image mining engine 106, the structured data received from the third party data sources 110, and/or the telematics data 112 described above may be stored by third parties instead of directly by the insurance company.

A relationship engine 107 analyzes data stored in the data warehouse 102 to draw linkages between individual datum which may not already be logically linked. The relationship engine stores data indicating relationships between data fields and data sources, instructions related to how to handle new data received from such data sources, and instructions indicating how to access data sources needed to obtain data for various data fields. For example, the relationship engine stores data linking speed limit map sources to location information. Thus, if an insured vehicle has an accident and its location is identified (e.g., by telematics data 112, by extraction by the text-mining engine 104 from a telephone transcript, or by entry into a structured data field of an insurance form ), the relationship engine is programmed to access the appropriate data source to determine the speed limit associated with that location. This information can then be used to determine whether the driver was speeding. Location information data fields may be linked both to GPS data fields and to locally stored or third-party satellite imagery. Similarly, the relationship engine 107 is programmed to respond to identification of a claimant as a lawyer by updating one or more appropriate data fields in the data warehouse, e.g., a field associated specifically with the claim identifying the claimant as an attorney and a global data table listing attorneys. Other data tables may be stored in the data warehouse 102 associating named individuals with other relevant characteristics, labels, or titles, including for example, convicted felons, doctors, drivers whose licenses have previously been suspended, etc.

By storing relationships between relevant structured data fields associated with specific claims and insurance applications with global data tables and data sources, the relationship engine 107 can identify relevant relationships within a claim or application for insurance and across multiple claims and/or applications. The relationship engine 107 can respond automatically in response to acquiring new information, or at the behest of the business logic processor 108 in response to a request for information.

Consider the following example. In handling one claim for a first customer, the insurance company learns that a particular individual is an attorney. The fact that a lawyer is involved in that claim is stored in the data warehouse in a lawyers data table. In a second claim, the insurance company learns via the text mining engine 104 that the claimant has had discussions with the named individual without being directly informed that the individual is an attorney. By processing the named individual through the relationship engine 107, the individual will be linked with his or her status as an attorney, and the data stored for the second claimant will be updated in the data warehouse 102 accordingly.

The relationship engine 107 is preferably implemented as computer executable instructions stored on a computer readable medium. In various implementations, the relationship engine 107 may be implemented on its own hardware platform, or within the data warehouse 102 or business logic processor 108.

The relationship engine 107 can also be employed to detect discrepancies in data received from multiple sources. For example, if in a form a customer indicates that an insured property is of a first size, and a third party data source 110, for example, a real estate information database, indicates that the property is of a second size, the relationship engine 107 can correct the data in the data warehouse 102 to reflect the information collected from the third party data source 110, which, while still prone to possible error, is more likely to be objective. Alternatively, the relationship engine can issue an alert which may then impact the insurance processing work flow. Similarly, in analyzing automobile accidents, the relationship engine can detect discrepancies between written accounts of the accident from different parties and telematics data 112 collected from vehicles involved in the accident. Note that discrepancy detection and fraud detection are not one and the same, though they are related. Discrepancies occur due to various factors, including different perceptions of events, fallible memories, and access to different information. In contrast, fraud implies some nefarious motivation behind a discrepancy, error, or omission.

Data stored in the data warehouse 102 can be analyzed by business logic processor 108. The data warehouse 102, the text mining engine 104, the image mining engine 106, the relationship engine 107, the documents 105, the third party data sources 110, and the telematics data 112 are linked with one another via one or more network connections (represented generally by network 115). The network links may include LAN links and WAN links (for example Internet links), as well as logical links, for example in implementations in which two or more of the business logic processor 108, relationship engine 107, the image mining engine 106, and text mining engine 104 are implemented on a common computing platform.

The business logic processor 108 includes two types of components, business rules and predictive models. The business logic processor 108 includes different combinations of business rules and predictive models for different functions. For example, in one implementation, the business logic processor 108 includes one or more predictive models and sets of business rules for the insurance company's major functions, for example, underwriting and claims processing. In the illustrative implementation, for claims processing purposes, the business logic processor 108 includes at least one predictive model and set of business rules substantially dedicated to identifying and responding to indicia of insurance fraud, at least one predictive model and set of business rules dedicated substantially to identifying and responding to the possibilities of obtaining subrogation for an insurance claim, and at least one predictive model and set of business rules related to determining predicting the losses associated with, and/or ultimate severity of the claim.

The claims processing business logic, in one implementation, also includes a predictive model and business rules for determining an ultimate severity of a claim. The ultimate severity of a claim corresponds to the total cost necessary to close the claim, including settlement fees and legal fees, if any. The ultimate severity of any claim may in fact be very different than the total value of the losses related to the claim. For example an insurer may determine it is likely to obtain at least partial subrogation of a claim from a third party, thereby reducing the ultimate severity to a level below the total loss amount. Conversely, an insurer may determine that a particular insured or victim will be unlikely to settle a claim without entering litigation, for example, if the claimant has engaged a contingency-fee attorney, therefore raising the ultimate severity of closing the claim to take into account legal fees and the uncertainty of jury awards.

The business rules involve usually only a small set of parameters and are usually binary in nature, though, in some cases, there may be more than two discrete possible outcomes. In a binary business rule, either the condition of the business rule is met, or it is not met. The consequences of the conditions being met take primarily two forms, actions and value adjustments. For example, two business rules related to underwriting might be the following:
If the customer has had an accident with the prior six months, then decline coverage; and/or
If the customer has had an accident with the prior six months, then increase premium prices by a predetermined percentage, e.g., 3%.
   Similar business rules may be applied for claims handling. Consider the following examples:
If a victim has spoken to a lawyer, then notifies the legal department of the claim; and/or
If a victim has spoken to a lawyer, then increase the ultimate severity prediction for the claim by a predetermined percentage, e.g., 25%.
   In some implementations, additional business rules control data gathering activities. For example, if a particular predictive model requires data for a predetermined number of parameters to produce a result exceeding a threshold confidence level, the business logic processor 108 may include a business rule that identifies parameters for which data is not available and which instructs the relationship engine 107 to retrieve data that can be retrieved automatically, or to cease processing until further information is obtained manually.

In general, the business rules may output directly into one or more of the predictive models, to the relationship engine 107, or to a separate workflow processing system.

A predictive model preferably takes into account a large number of parameters. The predictive models, in one implementation, are formed from neural networks trained on prior data and outcomes known to the insurance company. The specific data and outcomes analyzed vary depending on the desired functionality of the particular predictive model. For example, for a predictive model used to predict the ultimate severity of an insurance claim, in one implementation, the predictive model is trained on a collection of data known about prior insurance claims and their corresponding total disposition cost, including settlement and legal fees and other historical data. The particular data parameters selected for analysis in the training process are determined by using regression analysis and other statistical techniques known in the art for identifying relevant variables in multivariable systems. The parameters can be selected from any of the structured data parameters stored in the data warehouse 102, whether the parameters were input into the system originally in a structured format or whether they were extracted from previously unstructured text. In alternative implementations, the predictive models can be based on Baysean networks, Hidden Markov Models, decision trees, support vector machines, expert systems, or other systems known in the art for addressing problems with large numbers of variables.

The predictive models generate outputs corresponding to their function. For example, the underwriting predictive model, in one implementation, outputs a rating for a customer for a requested coverage. In another implementation, the underwriting predictive model outputs a premium price determined by the predictive model to be the appropriate cost to charge a customer for a requested coverage. The ultimate severity predictive model outputs a predicted total cost of disposition for a claim. In an alternative implementation, the ultimate severity predictive model outputs a reserve value indicating the amount of money the insurance company should keep in reserves to cover the likely costs of settling the claim based on the insurance company's reserve ratio for that particular line of business. Subrogation and fraud detection predictive models output probabilities indicating the likelihood of obtaining subrogation and the likelihood that a claim is fraudulent, respectively.

The predictive models may also output back into associated business rules that control work flow instructions. For example, if the fraud detection predictive model determines a substantial likelihood of fraud, for example, greater than a 30% chance, an associated fraud detection business rule outputs an instruction to a work flow processor to initiate an investigation into the potentially fraudulent matter. The threshold for issuing such an instruction used by the business rule may vary on the total value of the matter. For example, on the underwriting side, the likelihood of fraud needed for the business rule to issue such an instruction is tied to a requested liability limit. For the claims processing fraud detection business rule, the threshold is based on the value of the claimed loss. Similarly, an underwriting rating predictive model in one implementation outputs to a set of underwriting review business rules. These business rules determine that level of manual underwriting review imposed on the process based on the risk evaluation determined by the rating predictive model. Additionally, or alternatively, predictive model output may serve as input to another predictive model. For example the output of a fraud detection model may serve as an input to a model dedicated to calculating appropriate reserves for a claim or portfolio of claims.

Preferably, the insurance evaluation making system is dynamic in nature. That is, based on information learned from analyses and actions carried out by the business logic processor 108, the relationship engine 107, and the text mining engine 104, the predictive models are updated to reflect relevant information. For example, the predictive models can be used to detect trends in input data. For example, by analyzing extracted text in relation to outcomes, the predictive models can determine new structured parameters to include in an analysis and/or new weights to apply to previously known parameters. In addition, as new actual data is collected, for example, the actual ultimate severity of particular claims is learned, or the actual losses associated with a particular policy are experienced, the system can be retrained with the new outcome data to refine its analysis capabilities. In one implementation, the system is retrained on a monthly basis. In other embodiments, the system is trained on a weekly, quarterly, annual or continuous basis.

By having data obtained from the text-mining engine 104, the image mining engine 106, telematics data 112, and data made available from third party sources 110 available to make insurance related evaluations, insurance companies and their agents can make more accurate and nuanced evaluations of requests of insurance and insurance claims. Based on these more accurate and nuanced evaluations, better business decisions can be made. Consider the following examples:

### EXAMPLE 1

### Medical Verification

Based on claimant provided information, police, and doctors reports, an insurance company may learn that a claimant claims that an automobile accident caused a particular set of injuries. Using traditional data sources, an insurer may not be able to accurately determine whether the claimant is fraudulently asserting a prior or subsequent injury was the result of the accident, or whether the claimant's injuries have the potential to significantly worsen, therefore justifying more aggressive medical treatment than would otherwise be recommended. However, by obtaining collision data from sensors monitoring the claimant's vehicle, the insurer can learn the speed at which the vehicle was driving at the time of impact, its direction, and potentially even the angle and force of the impact. Historical databases relating such characteristics to likely medical outcomes are available. Such databases have limited value when data for relevant parameters is unavailable or untrustworthy.

### EXAMPLE 2

### Location Verification

Telematics data 112 from vehicle GPS can confirm whether an alleged incident occurred at a location extracted from text in a claims file by the text mining engine 104. For example, text mining might yield the assertion that the incident took place while parked in the claimant's driveway. The relationship engine 107 can then match the concept of “my driveway” to a particular address stored in the data warehouse 102 associated with the claimant's home. This data can then be compared both to the GPS data and to the Department of Motor Vehicles databases which store drivers' registered garaging addresses. The result of this analysis can identify the claimant as either being completely forthright, misstating the location of the vehicle, or possibly having outdated information in the DMV system.

### EXAMPLE 3

### Location Verification

The combination of telematics data 112 from an insured vehicle and data from a third party data source 110 can also be used to verify whether an insured's vehicle was actually hit by a particular vehicle, for example, a commercial truck, as alleged by the insured. For example, GPS data from the insured's vehicle can verify the location of the alleged incident. Data extracted from text in the claim file identifies the company to which the insured believes the truck to be affiliated with. Telematics data or truck routes can then be obtained from the alleged owner or operator of the truck, or other entity that monitors the position of the truck, to determine whether it was actually present at the site of the incident.

### EXAMPLE 4

### Analysis of Fire Damage

Assume an insured property experiences a fire. Text notes from the owner, witnesses, and even a trained inspector may not be sufficient to accurately assess the extent of structural damage experience by the property. Telematics data 112 and data from a third party data source 110 may be able to yield a more accurate assessment. Assume processing of an inspector's report indicates a discoloration on a support beam, which may be a sign of permanent structural damage. Data from temperature gauges within the property can be analyzed to determine the temperatures experienced by the discolored load bearing structures within the building, and the amount of time the structures were exposed to those temperatures. Structural engineering data can then be obtained to determine the likely impact of such exposure to the support structures.

### EXAMPLE 5

### Analysis of Storm Damage

In evaluating a claim for storm damage, data obtained from meteorological sensors in or near a damaged property can be analyzed and compared to data obtained from other data sources indicating historical weather patterns and events to determine whether claimed damage was likely sustained due to a storm. Further verification can be achieved by accessing product and structural engineering data bases to determine whether the detected storm conditions were likely sufficient to cause the claimed damage.

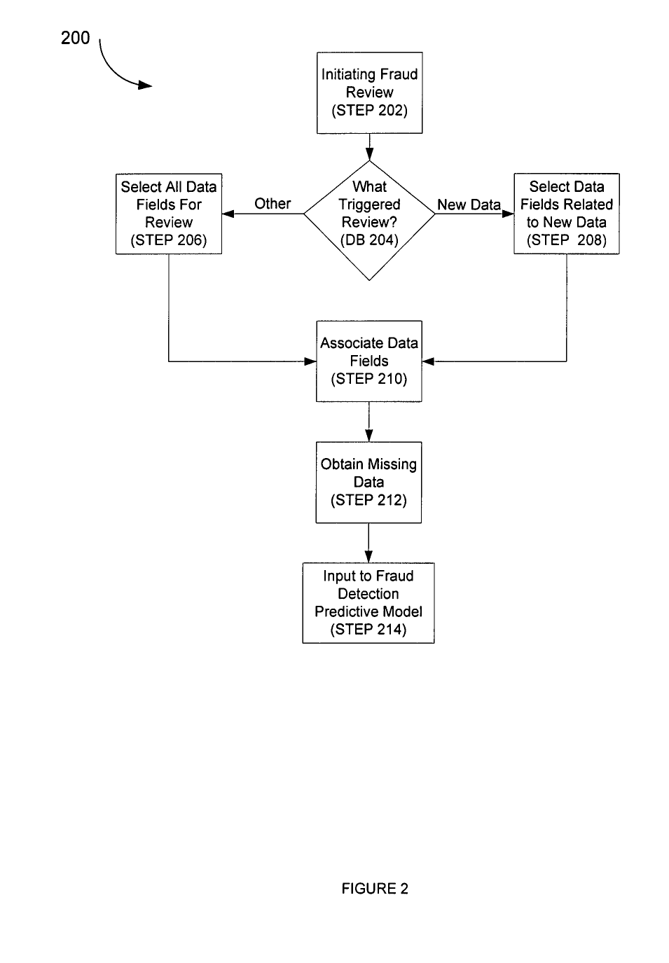

FIG. 2 is a flow chart illustrating a method 200 for detecting fraud using the system 6f FIG. 1, according to an illustrative embodiment of the invention. The method begins with initiating a fraud detection review of a claim or a claim or application for insurance (step 202). The method 200 may be initiated periodically across one or more claims or applications, at milestones associated with a specific claim, upon request, or whenever new information is received. Next it is determined whether the review is triggered by the receipt of new information or whether the request is based on a user request, a milestone being met, or a scheduled review date (decision block 204).

Based on the trigger for the review, a set of data fields are selected for fraud review. If the initiation is based on a user request, a milestone being met, or a scheduled review data, all data fields associated with the claim or application are selected for review (step 206). In alternative implementations, the set of fields reviewed based on analysis of prior fraud events to determine the fields most likely to be associated with fraud. If the initiation request is based on the receipt of new data, only data fields related to the new information are selected for review (step 208). The data in each field being reviewed is associated with data stored in fields indicated as being related by the relationship engine 107 (step 210).

If any related fields have not previously been populated, and the relationship engine 107 has a source for such data stored in its memory, the relationship engine executes stored instructions to obtain the missing data through the identified source (step 212). If the relationship engine 107 is unaware of a source for data, the relationship engine 107 initiates a search for a new data source. After all available data for the selected data fields are gathered, the gathered data is input into a fraud detection predictive model stored in the business logic processor (step 214). The predictive model takes into account telematics data in addition to data obtained from text mining and third party data sources 110.

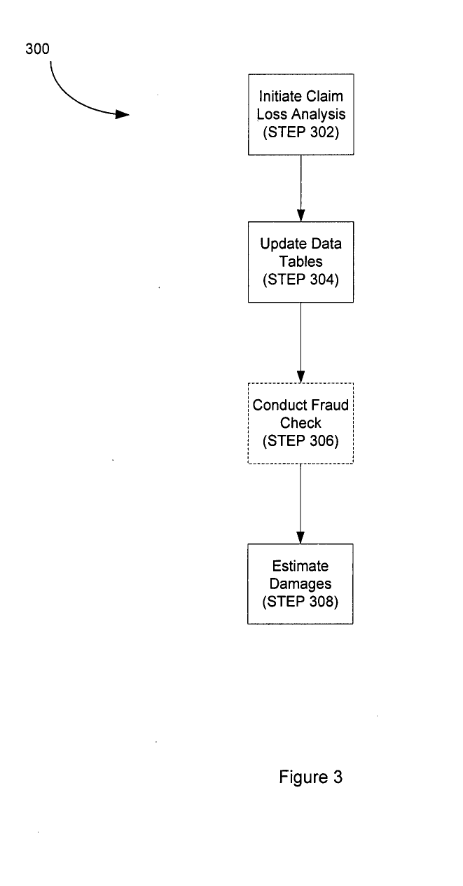

FIG. 3 is a flow chart of a method 300 for claim loss analysis using the system of FIG. 1, according to an illustrative embodiment of the invention. The process begins with the initiation of the claim loss analysis (step 302). The method 300 may be initiated periodically across one or more claims, at milestones associated with a specific claim, upon request, or whenever new information is received. Next, the business logic processor updates the data tables associated with the claim based on newly available information (step 304). Over time, insurance companies gain access to new types of data, either directly or through new or old third party data sources 110. Similarly, statistical analysis of additional claims may yield identification of additional relevant parameters or correlations between parameters. Thus, the new information may include newly received data, new types of data, and/or old data newly identified as being relevant to a particular claim evaluation.

After the information is updated, the claim is optionally checked for potential fraud (step 306), for example, according to method 200. Assuming no fraud is found, the data related to the claim, including telematics-based data, data collected from text mining, and data collected from third parties, are processed by the business logic processor to estimate the damages associated with the claim (step 308).

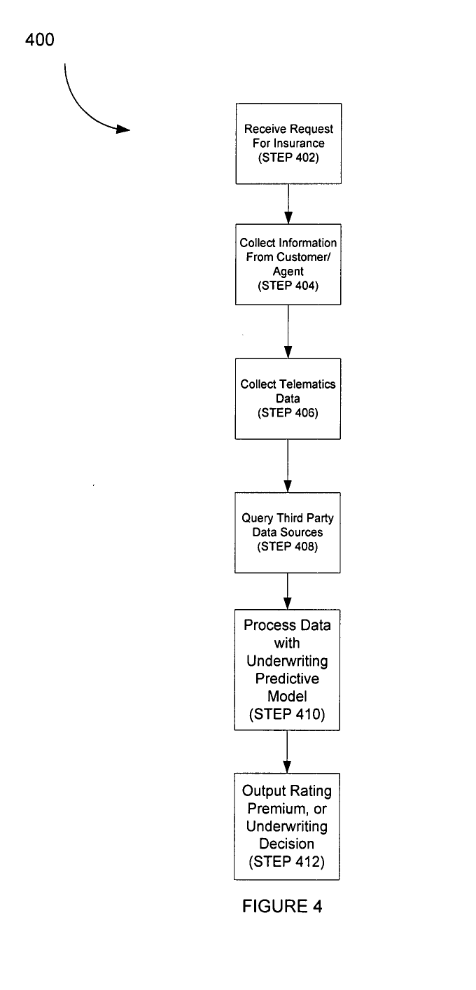

FIG. 4 is a flow chart of a method 400 for underwriting a request for insurance, which may be an original request or a renewal request, using the system of FIG. 1 according to an illustrative embodiment of the invention. The method begins with receiving a request for insurance (step 402). Next, information is collected from the customer or an agent acting on behalf of the customer (step 404). The data may be collected and over the phone by an insurance company employee who then manually enters the data into a data entry system. Alternatively, the phone conversation may be automatically transcribed by commercially available voice transcription to yield a transcript for processing by the text mining engine 104. In other alternative implementations, data is collected from the customer by use of a graphical user interface provided to the customer, for example, over the Internet.

Based on the customer-provided information, the system 100 collects telematics data related to the property the customer desires to have insured (step 406). For example, the system may query meteorological equipment in the vicinity of a structure being insured. The system may also query third party data sources 110 for information about the customer and the property (step 408). For example, the system may query government databases to obtain crime statistics for the location of the property to be insured. Similarly, the system may also obtain news articles pertaining to the customer, particularly for commercial customers. Data can be mined from the news articles to influence the underwriting process. For example, news reports of an impending hurricane or nearby wildfires which would likely cause an application for insurance to be rejected. The obtained data is then input into the business logic processor for processing by an underwriting predictive model (step 410). The underwriting predictive model then outputs a rating, premium, or other underwriting decision (step 412).

The invention may be embodied in other specific forms without departing form the spirit or essential characteristics thereof. The forgoing embodiments are therefore to be considered in all respects illustrative, rather than limiting of the invention.

What is claimed is:

1. A data analysis system comprising:
an information mining engine for extracting structured data from unstructured information;
a data store for storing the structured data output by the information mining engine, the data store further configured to receive data from a sensor monitoring an insured property and data from a third party data source; and
a business logic processor for collectively analyzing the structured data extracted by the information mining engine, the data received from the sensor, and the data received from the third party data source to make an insurance evaluation.

2. The data analysis system of claim 1, comprising a relationship engine configured to identify linkages between data fields stored in the data store.

3. The data analysis system of claim 2, wherein the relationship engine is configured to identify a linkage between a data field stored in the data store and a third party data source from which data is available to populate the data field.

4. The data analysis system of claim 2, wherein the relationship engine is configured to identify a linkage between a data field stored in the data store and the sensor monitoring the insured property in order to obtain data to populate the data field.

5. The data analysis system of claim 1, wherein the business logic processor comprises a predictive model for detecting fraud in an insurance claim based on a combination of the structured data extracted by the information mining engine, the data obtained from the sensor, and the data collected from the third party data source.

6. The data analysis system of claim 1, wherein the business logic processor comprises a predictive model for detecting fraud in an application for insurance based on a combination of the structured data extracted by the information mining engine, the data obtained from the sensor, and the data collected from the third party data source.

7. The data analysis system of claim 1, wherein the business logic processor comprises a predictive model for evaluating a loss associated with an insurance claim based on a combination of the structured data extracted by the information mining engine, the data obtained from the sensor, and the data collected from the third party data source.

8. The data analysis system of claim 1, wherein the business logic processor comprises a predictive model for underwriting an application for insurance based on a combination of the structured data extracted by the information mining engine, the data obtained from the sensor, and the data collected from the third party data source.

9. The data analysis system of claim 1, wherein the business logic processor comprises a predictive model that, in relation to a condition identified by the information mining engine, evaluates the import of collected sensor data based on data retrieved from a third party.

10. The data analysis system of claim 1, wherein the information mining engine comprises an image mining engine for extracting structured data from images or video.

11. A method of making an insurance evaluation comprising:
receiving data from an information mining engine, a third party data source, and a telematics sensor;
collectively processing the received data by a business logic processor including a predictive model; and
determining one of a likelihood of insurance fraud, a premium price, an underwriting rating, an estimated ultimate severity, and a likelihood of subrogation using the predictive model based on the combination of the data received from the information mining engine, the third party data source, and the telematics sensor.

12. The method of claim 11, comprising altering a step in an insurance work flow based on the determination.

13. The method of claim 11, comprising analyzing data received from the telematics sensor to verify data received from the information mining engine.

14. The method of claim 11, comprising analyzing data received from the telematics sensor and the third party data source to verify data received from the information mining engine.

15. The method of claim 11, comprising analyzing data received from the third party data source to verify data received from the information mining engine.

16. The method of claim 11, comprising analyzing data received from the third party data source and the third party data source to verify data received from the information mining engine.

17. The method of claim 11, wherein receiving data from the third party data source comprises receiving data from the third party data source based on the data received from the telematics sensor.

18. The method of claim 17, wherein the data from the third party data source is used to interpret the data received from the telematics sensor in relation to a condition identified by the information mining engine.

19. The method of claim 11, wherein receiving data from the third party data source comprises:
identifying at least one data field utilized by the predictive model for which data is not currently stored in a data store;
identifying the third party data source from which the data to populate the data field is available; and
querying the identified third party data source using the data received from the telematics sensor to obtain the data from the third party data source.

20. The method of claim 11, wherein receiving data from the third party data source comprises:
identifying at least one data field utilized by the predictive model for which data is not currently stored in a data store;
identifying the third party data source from which the data to populate the data field is available; and
querying the identified third party data source using the data received from the telematics sensor and the data received from the information mining engine to obtain the data from the third party data source.

21. The method of claim 11, comprising updating the predictive model based on the received data.

22. The method of claim 11, wherein the information mining engine comprises a text mining engine for extracting structured data from unstructured text.

23. A computer readable medium having computer-executable instructions for making insurance evaluations stored thereon, said computer-executable instructions, upon execution by a computer apparatus, cause the computer apparatus to perform:
receiving data from a telematics sensor, an information mining engine, and a third party data source, and;
processing the received data by a business logic processor including a predictive model; and
determining one of a likelihood of insurance fraud, a premium price, an underwriting rating, an estimated ultimate severity, and a likelihood of subrogation using the predictive model based on the combination of the data received from the information mining engine, the third party data source, and the telematics sensor.

24. The computer readable medium of claim 23, wherein obtaining data from the third party data source comprises:
identifying at least one data field utilized by the predictive model for which data is not currently stored in a data store;
identifying the third party data source from which the data to populate the data field is available; and
querying the identified third party data source using the data received from the telematics sensor and the data received from the information mining engine to obtain the data from the third party data source.

25. The computer readable medium of claim 23, wherein receiving data from the third party data source comprises receiving data from the third party data source based on the data received from the telematics sensor, and the data received from the third party data source is used to interpret the data received from the telematics sensor in relation to a condition identified by the information mining engine.
